(19) United States
(12) Patent Application Publication
(10) Pub. No.: US 2003/0006059 A1
(43) Pub. Date: Jan. 9, 2003

(54) Cell of free electric energy

(76) Inventor: Jerzy Mariusz Zaleski, Czestochowa (PL)

Correspondence Address: Arthur R. Gustowski, 770 Turnpike St, Stoughton, MA, 02072, US

(21) Appl. No.: 09/897,272

(22) Filed: Jul. 3, 2001

(51) Int. Cl. H01B 17/00

(52) U.S. Cl. 174/149 R

(57) ABSTRACT

System of electrical cells that can produce electrical energy without weather restrictions: during the day, in the night, with cloudy skies rainy day, or in the winter storm. Production of energy is independent of the place here on Earth. It is also possible to produce this energy in the moving objects: automobile, aircraft, or a boat. The production of energy can happen under the surface of the earth, under water, and in outer space.

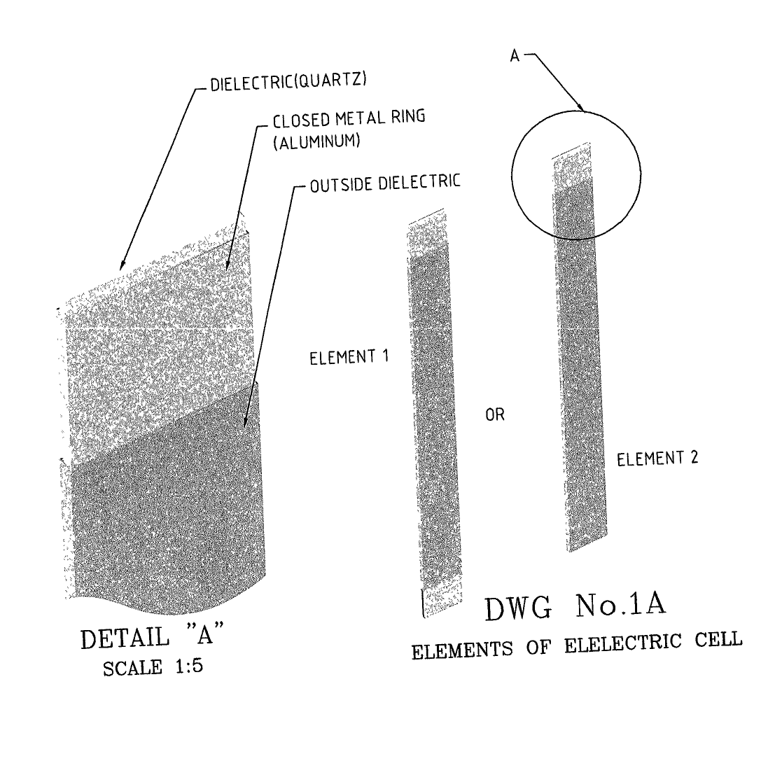

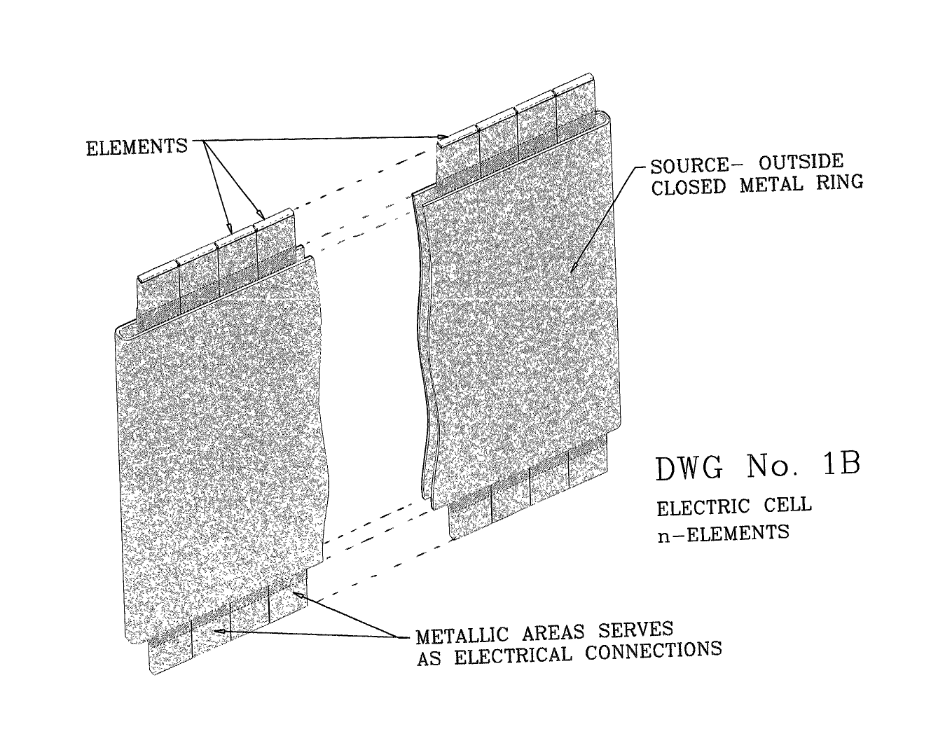

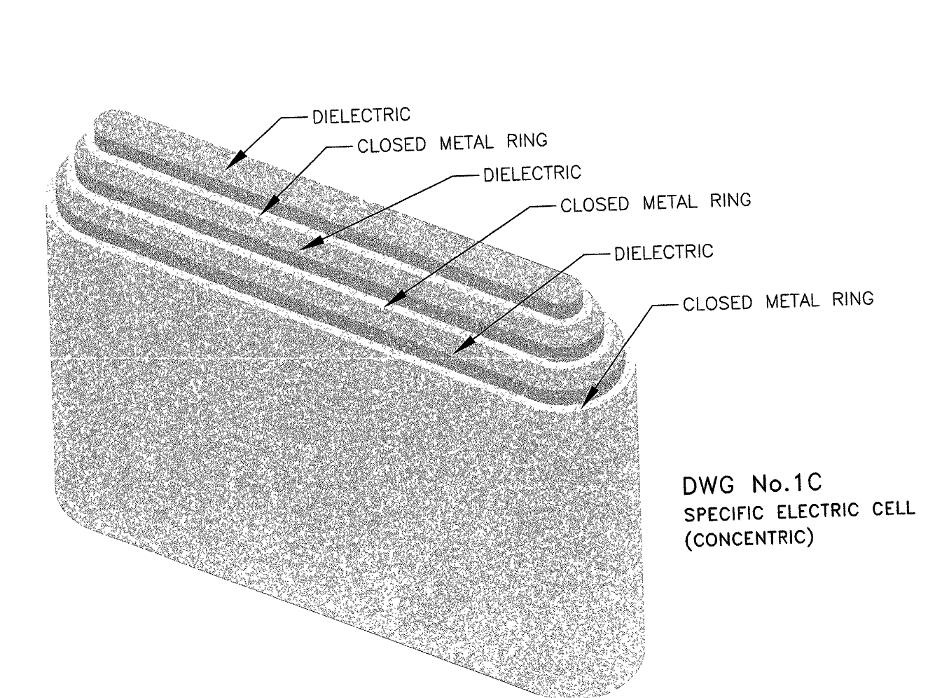

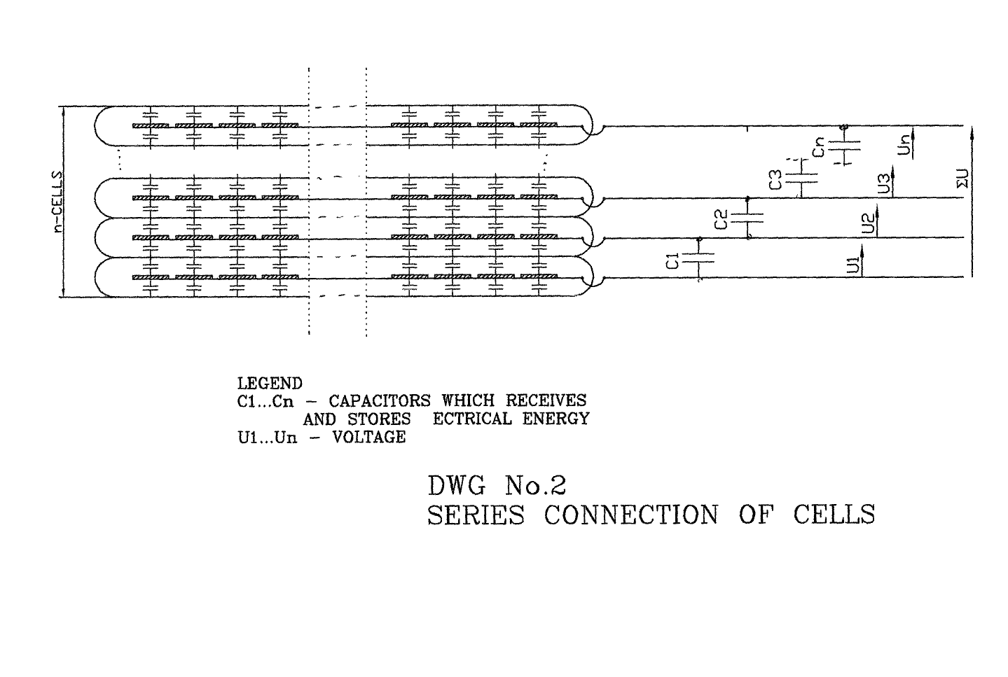

Presented here electrical cells are the only known to mankind devices, which can divide electrical charges that are inducted from torsion field.

### BACKGROUND OF INVENTION

Primary cosmic field has characteristics of torsion field, this field has any given physical shape and causes formation of torsion fields, whose way and formation is dependant on energy which is shape related, and always has its own characteristically multi-dimensional image. Our planet Earth is almost a sphere and the cosmic field reaching the Earth causes dextrorotatory torsion fields. Other objects which exist on Earth also cause formation of torsion fields characteristically to themselves. These torsion fields can be dextrorotatory or laevorotatory, they can also form either during the day or at night and without any regard to the weather or the state of cloud cover. The electric cell consists of elements in the shape of a flat rectangular prism best made of mountain crystal (quartz), which is rather thin and winded with a closed metal ring, for example made of aluminum. The outside surface of the elements should be coated with a high class dielectric for example ceramic whose epsilon (dielectric constant) is as high as possible and also delta (dielectric loss) as low as possible and at the same time Q (quality factor) as high as possible. The number of elements in a cell can be from one to a few dozen. The ends of the elements are not coated with dielectric material so that they could be joined together on contact. Compressed elements and those adjacent to each other that are wrapped with the ring made of metal tape that is in part dielectric isolated make up the cell. The cell described above and presented on DWG. No. 1B located in a torsion field causes induction of electric charges. With a homogeneous torsion field, the negative electric charges travel from the external metal ring (source) through dielectric to the metal coatings of the elements, causing a positive charge for the source in relation to the elements. In the case of different torsion fields charges on elements can have lower potentials as well as higher than the potential sources. The described system of electric cell causes the division of electric charges, a phenomenon practically unknown to mankind. Through appropriate joining of elements and source, we get a cell with a specified difference of electric potentials and specified productivity of current. The systems of joining the elements can be different, starting with constant connections to switching mechanically or electronically. The simplest solution is to plant the cell in a possible homogeneous field and then the elements have nearly identical or identical negative charges and after their joining they give the negative pole of the cell while the other pole is the source. By correctly receiving electric charges from cells for condenser systems we get a source of electric energy. DWG. No. 2 presents and example of a way of joining cells. There are practically no restrictions that have to do with tension or with voltage. The joined systems of cells can supply electrical energy without power restrictions and without regard to location, time of day, weather on the surface of the earth, underwater, in the air and also in space, even in the vacuum of space.

A specific case of electric cell are two, or more coaxial metal rings divided with dielectric, (DWG No. 1C) on which different electrical charges inducts. Each one of the rings poses different electrical potentials.

1. What I claim as my invention is: that dielectric elements in the shape of thin rectangular prisms coated with a closed metallic shell and isolated on the surface with a dielectric material situated next to each other and again wrapped with a closed metal ring and located in a torsion field induce electric charges which are divided and at the same time create a source of electric energy.

2. What I claim as my invention is: that closed metal rings residing coaxially, one inside another, and divided with dielectrics, also induct electrical charges as in claim No: 1.
